(19) United States
(12) Patent Application Publication
(10) Pub. No.: US 2021/0362676 A1
(43) Pub. Date: Nov. 25, 2021

(54) SYSTEMS AND METHODS FOR PROVIDING CUSTOMIZABLE VEHICLE SECURITY SETTINGS

(71) Applicant: Toyota Motor Engineering & Manufacturing North America, Inc., Plano, TX (US)

(72) Inventors: Xiao Xu, Ann Arbor, MI (US); Derek A. Thompson, Ypsilanti, MI (US)

(73) Assignee: Toyota Motor Engineering & Manufacturing North America, Inc., Plano, TX (US)

(21) Appl. No.: 16/882,004

(22) Filed: May 22, 2020

(51) Int. Cl. B60R 25/20; B60R 25/102; B60R 25/30; B60R 25/01; B60R 25/10; H04N 7/18; H04N 5/76; G06F 3/0482

(52) U.S. Cl. CPC B60R 25/20; B60R 25/102; B60R 25/30; B60R 25/01; B60R 2025/1016; H04N 7/183; H04N 5/76; G06F 3/0482; B60R 25/1004

(57) ABSTRACT

Embodiments herein are directed to a system that includes a user interface and a vehicle. The vehicle includes an electronic control unit communicatively coupled to the user interface. The electronic control unit includes one or more processors, one or more memory modules, and machine readable instructions stored in the one or more memory modules that cause the electronic control unit to perform at least the following: transmit a plurality of vehicle security options to the user interface, the plurality of vehicle security options selectable by a user to actuate one or more of the security components of the vehicle security system, receive an input from the user interface indicative of at least one selected option of the plurality of vehicle security options to be actuated, and enable the security system with the at least one selected option to be actuated when the vehicle security system is activated.

### TECHNICAL FIELD

Embodiments described herein generally relate to vehicle security systems and, more specifically, to vehicle systems that provide an ability to customize vehicle security settings.

### BACKGROUND

Currently, vehicles include a security system whereby all of a vehicle's doors are locked and an alarm is set. However, the security system is not customizable by a user such that the user can specify particular security measures to be taken when a security system is actuated.

### SUMMARY

In one embodiment, a system that includes a user interface and a vehicle is provided. The vehicle includes an electronic control unit communicatively coupled to the user interface. The electronic control unit is configured to operate a plurality of independently actuable security components of a vehicle security system. The electronic control unit includes one or more processors, one or more memory modules communicatively coupled to the one or more processors, and machine readable instructions stored in the one or more memory modules. The machine readable instructions cause the electronic control unit to perform at least the following when executed by the one or more processors: transmit a plurality of vehicle security options to the user interface, the plurality of vehicle security options selectable by a user to actuate one or more of the security components of the vehicle security system, receive an input from the user interface indicative of at least one selected option of the plurality of vehicle security options to be actuated when a security system is activated, and enable the security system with the at least one selected option to be actuated when the vehicle security system is activated.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an illustrative vehicle having a vehicle security system according to one or more embodiments shown and described herein;

FIG. 2A schematically depicts illustrative hardware components of an electronic control unit that may be used in performing a vehicle security mode according to one or more embodiments shown and described herein;

FIG. 2B schematically depicts an illustrative memory component containing illustrative logic components according to one or more embodiments shown and described herein;

FIG. 2C schematically depicts an illustrative data storage device containing illustrative data components according to one or more embodiments shown and described herein; and

FIG. 3 depicts a flow diagram of an illustrative method of performing a vehicle security mode using the vehicle security system of FIG. 1 according to one or more embodiments shown and described herein.

### DETAILED DESCRIPTION

The embodiments disclosed herein include vehicle security systems that are customizable by a user via a user interface to select a plurality of vehicle security options for when a vehicle is placed into a vehicle security mode. The vehicle security system includes an electronic control unit communicatively coupled to the user interface and configured to operate a plurality of independently actuable security components based on the plurality of vehicle security options. The plurality of vehicle security options may be determined based on a plurality of vehicle options and the user may choose which of the plurality of security options may occur during a vehicle security mode when a security system is activated. For example, the plurality of vehicle security options may include a door lock option, a window lock option, a trunk lock option, a window tint option, an alarm option, and an image activate option.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, and the like.

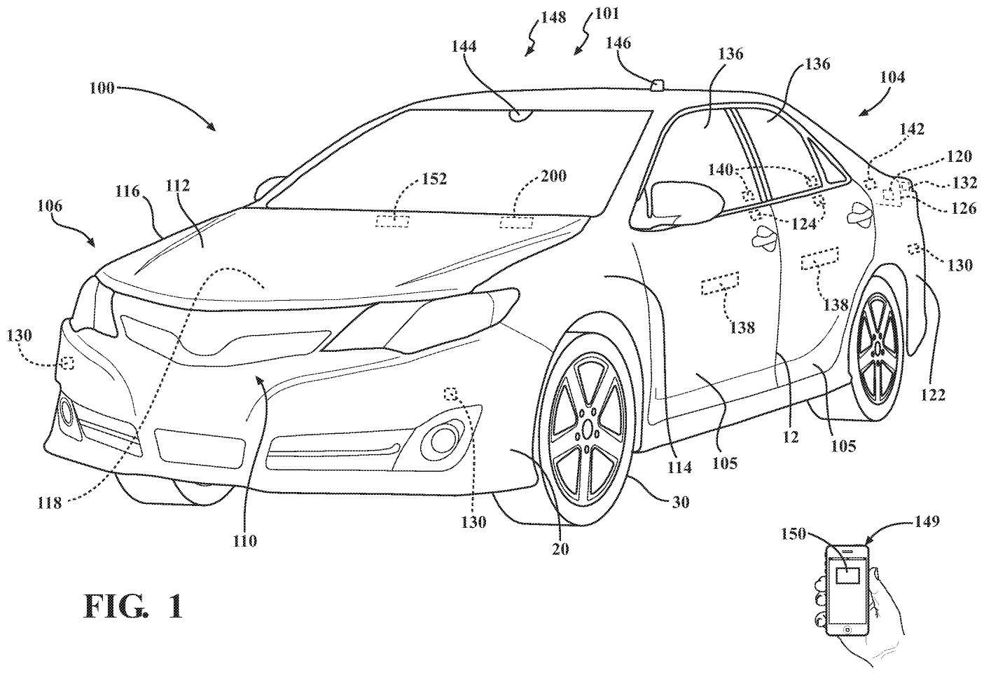

Referring initially to FIG. 1, a perspective view of a vehicle security system 100 is depicted. The vehicle security system 100 includes a vehicle 101, which includes a vehicle body 102 onto which a vehicle drivetrain is coupled. The vehicle 101 also includes a cabin 104 that is integral with the vehicle body 102. The cabin 104 generally defines a passenger cabin of the vehicle 101, which is enclosed by a plurality of doors 105. The vehicle 101 includes a front end assembly 106 and a rear end assembly 108. The front end assembly 106 includes front grille assembly 110 and a hood 112 located between a pair of front fenders 114 and 116 and spaces apart the front fenders 114 and 116 so to form an engine compartment 118. The rear end assembly 108 includes a trunk lid 120 or hatch located between a pair of rear quarter panels 122 and spaced apart from the pair of rear quarter panels 122 so to form a trunk area 126.

In addition, the front fenders 114 and 116 and/or the front grille assembly 110 may further include a front image capturing device 128 for capturing a plurality of images including live or streaming feeds in real time and/or a plurality of sensors 130 for sensing live vehicle environments such as whether a vehicle intrusion has occurred, as discussed in greater detail herein. Further, the rear quarter panels 122 and/or the trunk lid 120 may further include a rear image capturing device 132 for capturing a plurality of images including live or streaming feeds in real time and/or at least one of the plurality of sensors 130 for sensing live vehicle environments such as whether the vehicle intrusion has occurred, as discussed in greater detail herein.

In embodiments, each of the plurality of doors 105 may further include a window 136 that is moveable via a window actuator 138, between a plurality of positions. For example, between a closed position, as best shown in FIG. 1, and a fully open position. Further, in some embodiments, each window 136 of the plurality of doors 105 may further include a window tint mechanism 140 configured to change a shade of a tint of each window 136 of the plurality of doors 105. In some embodiments, each of the plurality of doors 105 may further include a door lock actuator 124 that is configured to lock and/or unlock each door of the plurality of doors 105 to the cabin 104 when the door is in a closed position, as best seen in FIG. 1. Further, in some embodiments, the trunk lid 120 or hatch may be movable via a trunk actuator 142 between an open position where the trunk lid 120 or hatch is spaced apart from the trunk area 126 and a closed position where the trunk lid 120 or hatch is encloses the trunk area 126, as best shown in FIG. 1.

In some embodiments, the vehicle 101 may further include an alarm device 144 configured to sound a horn or other alert of the vehicle when an intrusion is detected, as discussed in greater detail herein. Further, in some embodiments, the vehicle 101 further includes an antenna 146 configured to transmit and receive data, such as receiving commands from the user interface and transmitting the plurality of images to a network outside of the vehicle 101, as discussed in greater detail herein.

It should be appreciated that the plurality of independently actuable security components of the vehicle security system 100 may include the front image capturing device 128, plurality of sensors 130, the rear image capturing device 132 the window actuator 138, the window tint mechanism 140, the door lock actuator 124, the trunk actuator 142, and/or the alarm device 144.

The vehicle 101 may generally be any vehicle with one or more onboard computing devices, particularly computing devices that contain hardware for processing data, storing data, and capturing images in or around the vehicle. Thus, the vehicle 101 and/or components thereof may perform one or more computing functions, such as receiving data (e.g. from the antenna 146), capturing data (e.g., from the plurality of sensors 130, from the front image capturing device 128, and/or from the rear image capturing device 132), processing the received and/or captured data, storing the data, and providing processed data for vehicle security operations and/or detections of intrusions, as described in greater detail herein. It should be appreciated that the plurality of sensors 130, the front image capturing device 128, the rear image capturing device 132 and/or the antenna 146 are in communication with an electronic control unit 200. The electronic control unit 200 may be on board the vehicle 101. Further, it should be appreciated that the vehicle 101 may be an automobile or any other passenger or non-passenger vehicle such as, for example, a terrestrial, aquatic, and/or airborne vehicle.

The vehicle security system 100 may further include a user interface 148 that is communicatively coupled to the antenna 146. In some embodiments, the user interface 148 may be a smart mobile device 149 such as a smart phone, a laptop, a tablet, or a like portable handheld smart device. In other embodiments, the user interface 148 may be a wearable device such as a watch, smart glasses, and the like. Further, in other embodiments, the user interface 148 may be a vehicle's infotainment screen 152. That is, the user interface 148 may be embodied within the smart mobile device 149, the wearable device, or the vehicle's infotainment system 152. In other embodiments, the user interface 148 may be both the vehicle's infotainment screen 152 and the smart mobile device 149 or the wearable device (e.g., same interface is mirrored on both infotainment screen 152 and the smart mobile device 149 or the wearable device so that a user may select options remotely or from within the vehicle 101, as discussed in greater detail herein.

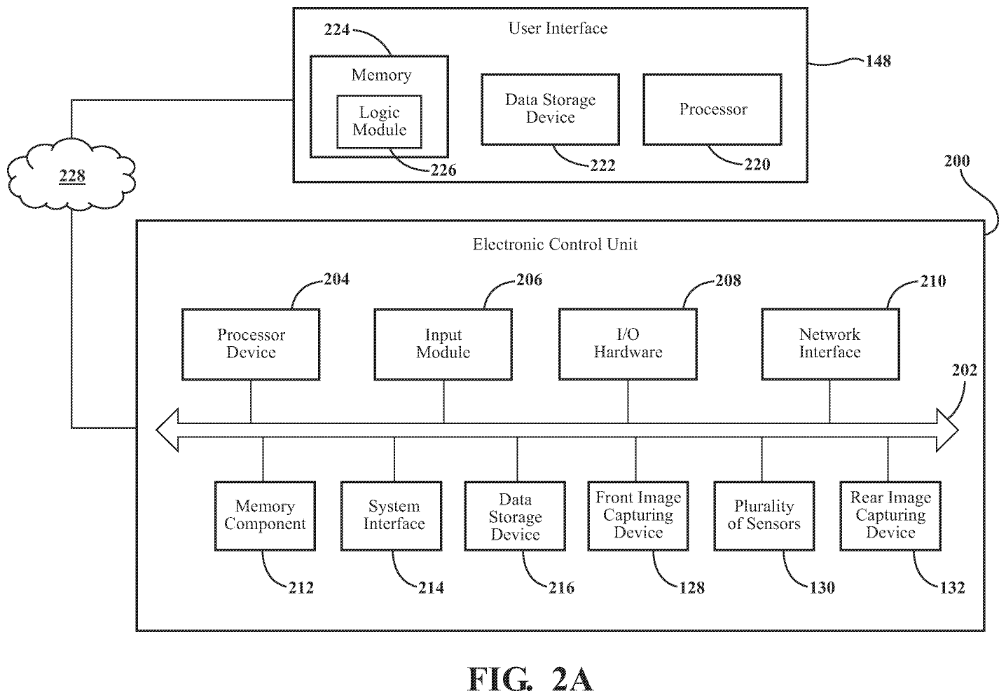

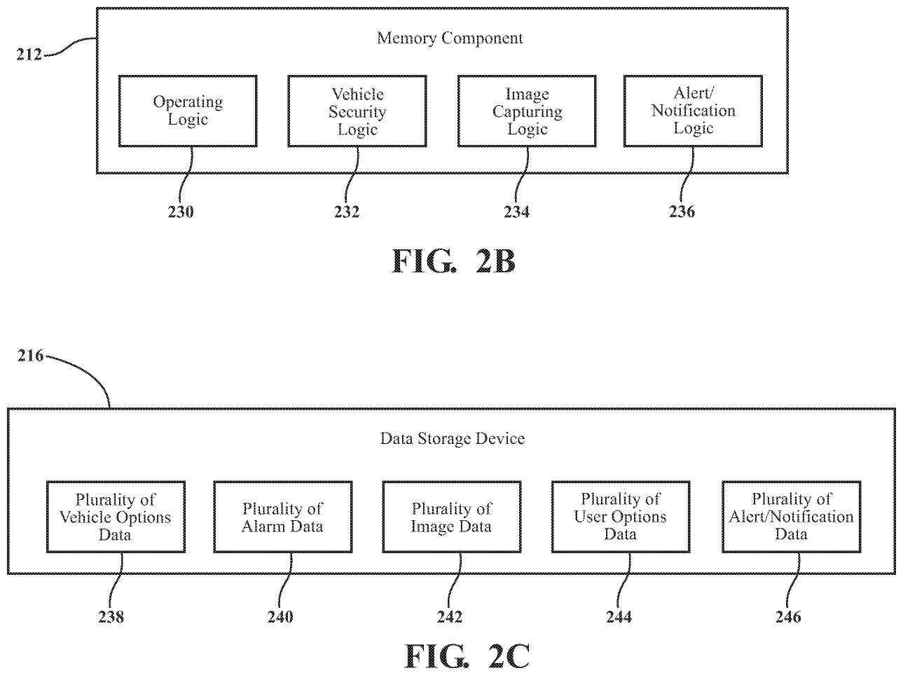

As discussed in greater detail below. The user interface 148 may include a display 150, a processor 220 (FIG. 2A), a memory component 224 (FIG. 2A) communicatively coupled to the processor 220 (FIG. 2A), and at least one logic module 226 (FIG. 2A) stored in the memory component 224 (FIG. 2A) that includes machine readable instructions. The machine readable instructions may cause the display 150 to, when executed by the processor 220 (FIG. 2A), launch and operate a plurality of vehicle security options and/or display an alert and/or a notification pushed from the electronic control unit 200 to the user interface 148, as discussed in greater detail herein.

As such, the electronic control unit 200 may be in communication with the antenna 146 and the user interface 148, as described in greater detail herein. That is, the user interface 148 may be configured to interact with the electronic control unit 200. In some embodiments, the user interface 148 is paired with the electronic control unit 200 of the vehicle 101 via a wired connection and/or a wireless connection. For the wireless connection, the antenna 146 is communicatively coupled to the user interface 148 and the electronic control unit 200 such that the user interface 148 is paired with the electronic control unit 200.

The plurality of sensors 130 may transmit a plurality of outputs, either wired or wirelessly, to the electronic control unit 200, as explained in greater detail herein. The plurality of sensors 130 may include laser scanners, capacitive displacement sensors, Doppler effect sensors, eddy-current sensors, ultrasonic sensors, magnetic sensors, optical sensors, radar sensors, sonar sensors, LIDAR sensors, any combination thereof, and/or any other type of sensor that one skilled in the art may appreciate that may be configured to detect an intrusion into the vehicle 101. It should be appreciated that the intrusion may mean any unwanted or undesirable attempt to or entry into the vehicle 101. As such, for example, an intrusion may be a detected vibration to the vehicle body 102, an attempt to or opening of one of the plurality of doors 105, an attempt to or opening of the trunk lid 120 or hatch, and/or the like.

FIG. 2A depicts various illustrative internal components of the electronic control unit 200 and internal components of the user interface 148. More specifically, the electronic control unit 200 may be communicatively coupled to the user interface 148 via a network 228. The network 228 may include a wide area network (WAN), such as the Internet, a local area network (LAN), a mobile communications network, a public service telephone network (PSTN), a personal area network (PAN), a metropolitan area network (MAN), a virtual private network (VPN), and/or another network that can electronically connected the electronic control unit 200 and the user interface 148 together.

In various embodiments, the user interface 148 may include, but is not limited to, the memory component 224, the data storage device 222, and the processor 220. The processor 220, such as a computer processing unit (CPU), may be the central processing unit of the user interface 148, performing calculations and logic operations to execute a program. The processor 220, alone or in conjunction with the other components, is an illustrative processing device, computing device, processor, or combination thereof. The processor 220 may include any processing component configured to receive and execute instructions (such as from the memory component 224).

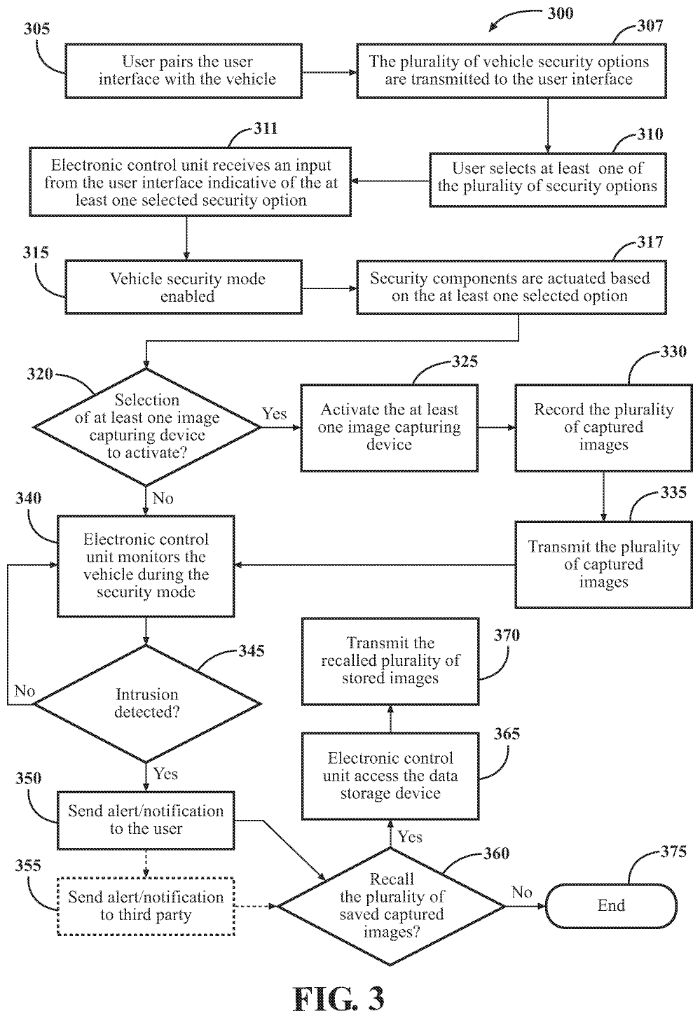

Still referring to FIG. 2A in some embodiments, the memory component 224 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. Further, the memory component 224 may be a non-transitory, processor-readable memory. The memory component 224 may include one or more programming instructions thereon that, when executed by the processor 220, cause the processor 220 to complete various processes, such as one or more of the processes described herein with respect to FIG. 3.

The programming instructions stored on the memory component 224 may be embodied as the one or more software logic modules 226, where each logic module 226 provides programming instructions for completing one or more tasks, as described in greater detail below with respect to FIG. 3. The logic module 226 includes a plurality of different pieces of logic, each of which may be embodied as a computer program, firmware, and/or software/hardware, which may be executable by the processor 220.

Still referring to FIG. 2A, the electronic control unit 200 is a non-transitory computer-readable medium that stores computer-readable programming instructions for completing the various processes described herein, embodied as hardware, software, and/or firmware, according to embodiments shown and described herein. While in some embodiments the electronic control unit 200 may be configured as a general purpose computer with the requisite hardware, software, and/or firmware, in other embodiments, the electronic control unit 200 may also be configured as a special purpose computer designed specifically for performing the functionality described herein. For example, the electronic control unit 200 may be a device that is particularly adapted to obtain a plurality of vehicle security options and transmit the plurality of vehicle security options to the user interface such that the user may customizable the plurality of security options such that the vehicle security system is actuated to the user's customized standards. In another example, the vehicle is monitored during the vehicle security mode and the alerts and/or notifies at least the user when the intrusion is detected. In embodiments where the electronic control unit 200 is a general purpose computer, the systems and methods described herein provide a mechanism for improving vehicle security modes by permitting the user to customize the plurality of vehicle security options based on the plurality of vehicle options provided in the specific vehicle from the user interface 148 and then monitoring the vehicle 101 for the intrusion and notifying at least the user when the intrusion is detected.

Still referring to FIG. 2A, the electronic control unit 200 may generally be an onboard vehicle computing system. In some embodiments, the electronic control unit 200 may be a plurality of vehicle computing systems. As also illustrated in FIG. 2A, the electronic control unit 200 may include a processor 204, an I/O hardware 208, a network interface hardware 210, a non-transitory memory component 212, a system interface 214, a data storage device 216, the plurality of sensors 130, the front image capturing device 128 and the rear image capturing device 132. A local interface 202, such as a bus or the like, may interconnect the various components.

It should be understood that the local interface 202 may be formed from any medium that is capable of transmitting a signal such as, for example, conductive wires, conductive traces, optical waveguides, or the like. In some embodiments, the local interface 202 may facilitate the transmission of wireless signals, such as Wi-Fi, Bluetooth, Near Field Communication (NFC) and the like. Further, it should be appreciated that the local interface 202 may communicatively couple the user interface 148 to the electronic control unit 200. Moreover, the local interface 202 may be formed from a combination of mediums capable of transmitting signals. In one embodiment, the local interface 202 comprises a combination of conductive traces, conductive wires, connectors, and buses that cooperate to permit the transmission of electrical data signals to components such as processors, memories, sensors, input devices, output devices, and user interfaces. Accordingly, the local interface 202 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The processor 204, such as a computer processing unit (CPU), may be the central processing unit of the electronic control unit 200, performing calculations and logic operations to execute a program. The processor 204, alone or in conjunction with the other components, is an illustrative processing device, computing device, processor, or combination thereof. The processor 204 may include any processing component configured to receive and execute instructions (such as from the data storage device 216 and/or the memory component 212).

The memory component 212 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. The memory component 212 may include one or more programming instructions thereon that, when executed by the processor 204, cause the processor 204 to complete various processes, such as the processes described herein with respect to FIG. 3. Still referring to FIG. 2A, the programming instructions stored on the memory component 212 may be embodied as a plurality of software logic modules, where each logic module provides programming instructions for completing one or more tasks, as described in greater detail below with respect to FIG. 2B.

The network interface hardware 210 may include any wired or wireless networking hardware, such as a modem, a LAN port, a wireless fidelity (Wi-Fi) card, WiMax card, mobile communications hardware, the antenna 146 (FIG. 1), and/or other hardware for communicating with other networks and/or devices. For example, the network interface hardware 210 may provide a communications link between the vehicle 101 (FIG. 1) and the other components of a network such as a network 228, satellites, user computing devices, server computing devices, and the like. That is, in embodiments, the network interface hardware 210 is configured to receive signals from the network 228 and includes one or more conductive elements that interact with electromagnetic signals transmitted by the network 228. The received signal is transformed into a data signal indicative of the command from the user via the user interface 148, such as the customized security options. Thus, the network interface hardware 210 allows the vehicle 101 to have customized security options from the user who is remotely located with respect to the vehicle 101 (FIG. 1).

Still referring to FIG. 2A, the data storage device 216, which may generally be a storage medium, may contain one or more data repositories for storing data that is received and/or generated. The data storage device 216 may be any physical storage medium, including, but not limited to, a hard disk drive (HDD), memory, removable storage, and/or the like. While the data storage device 216 is depicted as a local device, it should be understood that the data storage device 216 may be a remote storage device, such as, for example, a server computing device or the like. Illustrative data that may be contained within the data storage device 216 is described below with respect to FIG. 2C.

Still referring to FIG. 2A, the I/O hardware 208 may communicate information between the local interface 202 and one or more other components of the vehicle 101. For example, the I/O hardware 208 may act as an interface between the electronic control unit 200 and other components, such as the plurality of sensors 130, the user interface 148, a head end unit, navigation systems, meter units, infotainment systems, and/or the like. In some embodiments, the I/O hardware 208 may be utilized to transmit one or more commands to the other components of the vehicle 101.

The system interface 214 may generally provide the electronic control unit 200 with an ability to interface with one or more external devices such as, for example, the user interface 148, such that the electronic control unit 200 may receive information and/or data from the user interface 148 and push a notification or alert to the user interface 148. As such, the system interface 214 permits bidirectional communication between the electronic control unit 200 and the user interface 148.

Still referring to FIG. 2A, the plurality of sensors 130 may be communicatively coupled to the local interface 202 and communicatively coupled to the processor 204 via the local interface 202. The plurality of sensors 130 may be any sensing device, sensor, or detector that is suitable for obtaining or collecting data. Any suitable commercially available sensors may be used for the plurality of sensors 130 without departing from the scope of the present disclosure. In some embodiments, the plurality of sensors 130 may be coupled to one or more other components that provide additional functionality for sensing, such as, for example, an image capturing device that captures images, whether still or video (a sequence of dynamic photos).

The front image capturing device 128 may be communicatively coupled to the local interface 202 and coupled to the processor 204 via the local interface 202. The front image capturing device 128 may be any imaging device, sensor, or detector that is suitable for obtaining images. As used herein, the term “images” or “image” refers to video images (i.e., a sequence of consecutive images), still images (including still images isolated from video images), and/or image data. Any suitable commercially available front image capturing device 128 may be used without departing from the scope of the present disclosure. In some embodiments, the front image capturing device 128 may be coupled to one or more other components that provide additional functionality for imaging, such as, for example, one or more sensors.

The front image capturing device 128 may include or may be coupled to a lens (not shown). The lens is not limited by this disclosure and may generally be any optical component that is configured to focus the light entering the front image capturing device 128 such that an image can be properly obtained. In some embodiments, the lens may be a fixed lens that is not adjustable. In other embodiments, the lens may be adjustable, either manually or automatically by the processor 204, to zoom in on an object, zoom out on an object, and/or adjust the focus of the light entering the front image capturing device 128.

The rear image capturing device 132 may be communicatively coupled to the local interface 202 and coupled to the processor 204 via the local interface 202. The rear image capturing device 132 may be any imaging device, sensor, or detector that is suitable for obtaining images. Any suitable commercially available rear image capturing device 132 may be used without departing from the scope of the present disclosure. In some embodiments, the rear image capturing device 132 may be coupled to one or more other components that provide additional functionality for imaging, such as, for example, one or more sensors.

The rear image capturing device 132 may include or may be coupled to a lens (not shown). The lens is not limited by this disclosure and may generally be any optical component that is configured to focus the light entering the rear image capturing device 132 such that an image can be properly obtained. In some embodiments, the lens may be a fixed lens that is not adjustable. In other embodiments, the lens may be adjustable, either manually or automatically by the processor 204, to zoom in on an object, zoom out on an object, and/or adjust the focus of the light entering the rear image capturing device 132.

With reference to FIG. 2B, in some embodiments, the program instructions contained on the memory component 212 may be embodied as a plurality of software modules, where each module provides programming instructions, machine readable and executable instructions, and/or the like, for completing one or more tasks. The programming instructions, machine readable and executable instructions, and the like may comprise logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, and the like, that may be compiled or assembled into machine readable and executable instructions and stored on the one or more memory component 212. Alternatively, the programming instructions, machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

For example, FIG. 2B schematically depicts the memory component 212 containing illustrative logic components according to one or more embodiments shown and described herein. As shown in FIG. 2B, the memory component 212 may be configured to store various processing logic, such as, for example, an operating logic 230, a vehicle security logic 232, an image capturing logic 234 and/or an alert/notification logic 236 (each of which may be embodied as a computer program, firmware, or hardware, as an example).

Still referring to FIG. 2B, the operating logic 230 may include an operating system and/or other software for managing components of the electronic control unit 200 (FIG. 2A). Further, the operating logic 230 may contain one or more software modules for monitoring data, transmitting data, and/or analyzing data. The vehicle security logic 232 may contain one or more software modules and/or other software for managing components of the electronic control unit 200 (FIG. 2A). Further, the vehicle security logic 232 may contain one or more software modules for monitoring data, transmitting data, analyzing data, collecting data and/or determining whether an intrusion has occurred. For example, the vehicle security logic 232 may determine the plurality of vehicle security options, assist in transmitting the options to the user interface 148, receive the selected options of the plurality of vehicle security options and assist in facilitating the vehicle security mode according to the selected options of the plurality of security options. The vehicle security logic 232 may collect data from one or more sources (e.g. the plurality of sensors 130, the front image capturing device 128 and the rear image capturing device 132 depicted in FIG. 1, and/or the like), as described in greater detail herein.

The image capturing logic 234 may contain one or more software modules for receiving data, monitoring data, transmitting data, and/or analyzing data to provide the user interface 148 and other components (e.g., the head unit, infotainment system, and the like) with the plurality of images. The image capturing logic 234 may be initiated as one of the selected vehicle security options and/or may be initiated when the intrusion is determined. As such, the image capturing logic 234 may assist in activating the front image capturing device 128, the rear image capturing device 132, the plurality of sensors 130, and the like.

The alert/notification logic 236 may contain one or more software modules for receiving data, monitoring data, transmitting data, and/or analyzing data to provide the user interface 148 with the alert/notification of the intrusion. Further, the alert/notification logic 236 may provide third parties, such as insurance companies, law enforcement, and the like, with the alert/notification of the intrusion. The alert/notification may be a SMS message, a ring, a graphic and the like pushed to the user interface 148 and/or to the third party.

FIG. 2C schematically depicts a block diagram of various data contained within a storage device (e.g., the data storage device 216). As shown in FIG. 2C, the data storage device 216 may include, for example, a plurality of vehicle options data 238 that may be preprogrammed such as by the manufacturer, at the factory, and the like, and/or may be customizable for each vehicle type. The plurality of vehicle options data 238 may be identified from data received from a plurality of vehicle components, and the like. For example, the window tint mechanism 140 (FIG. 1), the trunk actuator 142 (FIG. 1), the front image capturing device 128 (FIG. 1), the rear image capturing device 132 (FIG. 1), and/or the like may be preprogrammed or may be identified from the data received from each of the vehicle components.

The data storage device 216 may further include, for example, a plurality of alarm data 240, such as the data related to when the intrusion occurs. For example, when the vehicle 101 (FIG. 1) is in the security mode and an attempt is made to open one of the plurality of doors 105 (FIG. 1) (for instance via a door handle), the action may be compared with the plurality of alarm data 240 to determine whether the action is an intrusion. In another example, when the vehicle 101 (FIG. 1) is in the vehicle security mode, a vibration of the vehicle body 102 (FIG. 1) may be compared with the plurality of alarm data 240 to determine whether the vibration is an intrusion.

Further, the data storage device 216 may include, for example, a plurality of image data 242. The data captured from the front image capturing device 128 (FIG. 1), the rear image capturing device 132 (FIG. 1) and/or the plurality of sensors 130 (FIG. 1) may be stored as the plurality of image data 242. It should be appreciated that while the data captured from the front image capturing device 128 (FIG. 1), the rear image capturing device 132 (FIG. 1) and/or the plurality of sensors 130 may be recorded as the plurality of image data 242, the data may be live streamed to the user interface 148 (FIG. 1), as discussed in greater detail herein. Further, the plurality of image data 242 may be recalled and extracted after being recorded for use by the user, law enforcement, insurance companies, and the like. As such, It should be appreciated that the plurality of image data 242 may not be stored permanently, but instead may be stored temporarily such that the data may be extracted therefrom. It should also be appreciated that any image processing technology may be used to process images from the front image capturing device 128 (FIG. 1), the rear image capturing device 132 (FIG. 1) and/or the plurality of sensors 130 (FIG. 1).

The data storage device 216 may further include, for example, a plurality of user options data 244 in which the user may customize the vehicle security mode by manipulating the plurality of vehicle security options for the vehicle 101 (FIG. 1) as identified from data received from a plurality of vehicle components or preprogrammed. That is, the user may be able to customize which vehicle security options are selected during the security mode. For example, the user may be able to select whether the window tint mechanism 140 (FIG. 1) is actuated, whether the window actuator 138 is actuated, whether the trunk actuator 142 (FIG. 1) is actuated to position the trunk into the closed position, whether the front image capturing device 128 (FIG. 1) is activated, the rear image capturing device 132 (FIG. 1) is activated, whether the door lock actuator 124 is actuated to lock and/or unlock each door of the plurality of doors 105, whether the alarm device 144 is activated, and the like. As such, the selected user vehicle security options are stored and continuously customizable. That is, the user may edit or change the selected user vehicle security options either remotely via the user interface 148 (FIG. 1) and/or an onboard vehicle component such as the head unit or infotainment system.

The plurality of user options data 244 may further include, for example, data related to the type of user interface 148 (FIG. 1), the connectivity of the device, the type of the display (e.g., the display 150 of the user interface 148 (FIG. 1)) such as whether the display is an optical output such as, for example, a cathode ray tube, a light emitting diode (LED) display, an organic light emitting diode (OLED) display, a liquid crystal display, a plasma display, and/or the like. Further, the plurality of user options data 244 may include information relating to the operating system of the user interface 148 (FIG. 1), the type of device, and the like, such that the plurality of vehicle security options and/or the alert/notification may be pushed to the user interface 148 (FIG. 1).

The data storage device 216 further includes a plurality of alert/notification data 246, which may be received from the plurality of sensors 130 (FIG. 1), as discussed in greater detail herein. The plurality of sensors 130 (FIG. 1) are positioned either on or within the vehicle 101 (FIG. 1) and may capture data such whether an action or other event is an intrusion attempt into the vehicle during the vehicle lock down mode. In some embodiments, the plurality of sensors 130 (FIG. 1) detect an undesirable condition of the vehicle 101 during the vehicle security mode such as an attempt to enter the vehicle through the plurality of doors 105 (FIG. 1), the trunk lid 120 (FIG. 1), and the like. The plurality of sensors 130 (FIG. 1) may be any device capable of outputting a signal indicative of a potential intrusion. Some embodiments may not include the plurality of sensors 130 (FIG. 1). Based on the identified potential intrusion, the electronic control unit 200 may determine whether an undesirable condition is present. Then, the electronic control unit 200 may determine whether or not to initiate an alert/notification to be pushed to the user via the user interface 148 (FIG. 1).

It should be understood that the components illustrated in FIGS. 2A-2C are merely illustrative and are not intended to limit the scope of this disclosure. More specifically, while the components in FIGS. 2A-2C are illustrated as residing within the electronic control unit 200 of the vehicle 101, this is a non-limiting example. In some embodiments, one or more of the components may reside external to the electronic control unit 200 and/or the vehicle 101 (FIG. 1).

As mentioned above, the various components described with respect to FIGS. 2A-2C may be used to carry out one or more processes for a customizable vehicle security system where specific options may be selected from a plurality of vehicle security options. The plurality of vehicle security options may be determined based on a plurality of vehicle options and the user may choose which of the plurality of options may occur during a vehicle security mode.

FIG. 3 depicts an illustrative method 300 for customizing the plurality of vehicle security options of independently actuable security components of the vehicle security system. At block 305, the user pairs the user interface with the vehicle and in particular with the electronic control unit. It should be understood that this pairing may be performed through a plurality of methods, such as using applications, in vehicle wired or wireless conductivity, and the like, as will be readily apparent to those skilled in the art. If the user interface is not paired with the vehicle, the process 300 may continue with the user locally using other vehicle components, such as the vehicle head unit, infotainment system and the like.

Once paired, the plurality of vehicle security options are transmitted to the user interface, at block 307. The user selects at least one of the plurality of vehicle security options displayed on the user interface, at block 310. It should be appreciated that the plurality of vehicle security options may be based on the options equipped within the vehicle. For example, the user may select that when a security mode occurs, the window of the windows are positioned or moved into the closed position, the plurality of doors are locked, and/or the trunk is placed in the closed position. In another example, the user may also select that when a security mode occurs, the windows are tinted, the front and rear imaging capturing devices are activated, and/or the alarm is activated.

Once the plurality of vehicle security options are selected, the electronic control unit receives the input from the user interface indicative of the at least one selected vehicle security option, at block 311 and the vehicle security mode is enabled based on the at least one selected vehicle security option, at block 315. It should be appreciated that when the vehicle security mode is enabled, the selected vehicle security options of the plurality of vehicle security options are independently actuable by the various security components (i.e., the window actuator, the door lock actuator, the trunk actuator, and the like), at block 317. At block 320, the electronic control unit determines whether the selected plurality of vehicle security options includes the selection of the image capturing devices to activate. If the electronic control unit determines that the user selected the image capturing devices to activate, the electronic control unit activates at least one of the image capturing device, at block 325, records the plurality of captured images, at block 330 transmits the plurality of captured images to the user interface, at block 335 and the electronic control unit monitors the vehicle during the security mode, at block 340. If the electronic control unit determines that the selected plurality of vehicle security options does not include the selection of the image capturing devices to activate, at block 320, then the electronic control unit monitors the vehicle during the security mode, at block 340.

At block 345, the electronic control unit determines whether an intrusion of the vehicle is detected. If the electronic control unit determines that there is not an intrusion at block 345, then the electronic control unit continues to monitor the vehicle while the vehicle remains in the vehicle security mode, at block 340. It should be appreciated that block 340 and block 345 may continuously loop until an intrusion is detected at block 345 or until the vehicle is no longer in the vehicle security mode. At block 345, when an intrusion is detected, the electronic control unit sends the alert/notification to the user via the user interface, at block 350, may send an alert/notification to the third party at block 355, as a selected option, indicated by the dotted line. It should be appreciated that the third party may be law enforcement, insurance companies, and the like.

At block 360, the electronic control unit may be instructed to recall the plurality of saved captured images by the user and/or by the third parties. When the recall command is received, the electronic control unit may access the data storage device, at block 365, to obtain the plurality of images just prior and during the detected intrusions and transmits the obtained the plurality of images, at block 370, to the user and/or third party via the user interface, the head end unit, the infotainment system, and the like. If the electronic control unit is not instructed to recall the plurality of saved captured images at block 360, the process 300 ends at block 375.

According to the present subject matter, a customizable vehicle security system that permits a user, either remotely by a user interface, or within the vehicle by an infotainment system of the vehicle, to select a plurality of vehicle security options for a vehicle security mode is provided. The plurality of vehicle security options may vary depending on the options of the vehicle. The vehicle security system includes an electronic control unit that operates a plurality of security components based on the plurality of vehicle security options. The user may select from the available plurality of vehicle security options, which occur during the vehicle security mode. For example, the plurality of vehicle security options may include a door lock option, a window move option, a trunk move option, a window tint option, an alarm option, and an image capture activate option.

The vehicle security system monitors the vehicle and determines whether an intrusion occurs and activates at least one image capturing device automatically such that at least one image capturing devices of the vehicle captures and records a plurality of real time images, which may be recalled for the user to view and/or for a plurality of third parties to review, such as insurance agencies, police departments, and the like. Further, upon the intrusion detection, the user may be notified of the intrusion as well predetermined third parties.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system comprising:
a user interface; and
a vehicle having an electronic control unit communicatively coupled to the user interface, wherein the electronic control unit is configured to:
transmit a plurality of available vehicle security options to the user interface, the plurality of available vehicle security options selectable by a user to indicate one or more security components of a vehicle security system to be actuated upon activation of the vehicle security system, the one or more security components selected from a window actuator, a door lock actuator, a window tint mechanism, a trunk actuator, and an alarm device;
receive an input from the user interface indicative of a plurality of selected options of the plurality of available vehicle security options; and
enable the vehicle security system with the plurality of selected options to be actuated when the vehicle security system is activated when a single control input is received.

2. The system of claim 1, wherein the electronic control unit is further configured to:
place the vehicle into a security mode by actuating the plurality of independently actuable security components according to the plurality of selected options of the plurality of available vehicle security options.

3. The system of claim 2, wherein the electronic control unit is further configured to:
monitor vehicle information;
determine whether an intrusion has occurred based on the monitored vehicle information; and
alert the user interface of the determined intrusion.

4. The system of claim 3, wherein the alert is a notification displayed on the user interface.

5. The system of claim 3, further comprising:
at least one image capturing device coupled to the vehicle and communicatively coupled to the electronic control unit.

6. The system of claim 5 wherein the electronic control unit is further configured to:
determine whether the plurality of selected options of the plurality of available vehicle security options is an image selected option;
activate the at least one image capturing device to capture a plurality of real time images;
record the plurality of real time images onto a database; and
transmit the plurality of real time images to the user interface.

7. The system of claim 6, wherein the plurality of real time images recorded onto the database are recalled following the determined intrusion.

8. The system of claim 1, wherein when a door lock option is selected, the electronic control unit causes the door lock actuator to move from an unlocked position to a locked positon.

9. The system of claim 1, wherein when a window lock option is selected, the electronic control unit causes the window actuator to move a window from an unlocked position to a locked position.

10. The system of claim 1, wherein when a trunk lock option is selected, the electronic control unit causes the trunk actuator to move a trunk from an open position to a closed position.

11. The system of claim 1, wherein when a window tint option is selected, the electronic control unit causes the window tint mechanism to change a tint of a window.

12. The system of claim 1, wherein when an alarm set option is selected, the electronic control unit causes the alarm device to change from an unarmed state to an armed state.

13. The system of claim 1, wherein the user interface is a wearable device or an infotainment screen of the vehicle.

14. The system of claim 1, wherein the user interface is a portable electronic device.

15. The system of claim 14, wherein the portable electronic device is from a group of a smart phone, a tablet, and a laptop.
